(19) United States
(12) Patent Application Publication
(10) Pub. No.: US 2008/0143021 A1
(43) Pub. Date: Jun. 19, 2008

(54) Method For Finely Polishing/Structuring Thermosensitive Dielectric Materials By A Laser Beam

(76) Inventors: Lutz Ehrentraut, Berlin (DE); Ingolf Hertel, Berlin (DE); Arkadi Rosenfeld, Berlin (DE)

Correspondence Address: THELEN REID BROWN RAYSMAN & STEINER LLP, P.O. BOX 640640, SAN JOSE, CA, 95164-0640, US

(21) Appl. No.: 11/911,200

(22) PCT Filed: Mar. 21, 2006
(86) PCT No.: PCT/EP06/60921

§ 371 Date: Oct. 11, 2007

(30) Foreign Application Priority Data
Apr. 22, 2005 (DE) 10 2005 020 072.9

(51) Int. Cl. B29C 35/08

(52) U.S. Cl. 264/400

(57) ABSTRACT

The invention relates to a method for finely polishing/structuring thermosensitive dielectric materials, in particular materials exhibiting a low thermal expansion coefficient, by a laser beam consisting in directing an intensive ultrashort laser beam to a processable material surface, in adjusting the action time within a range from 10-13 s to 10-11 s and a laser pulse energy in such a way that it is less than an ablation threshold but sufficient for provoking a Coulomb explosion. The inventive method makes it possible to carry out a material removal within a nanometer range by means of laser ultrashort pulses ranging between picoseconds and subpicoseconds, wherein the material surface is finely polished during a pre-ablation process step (removal less than the ablation range) and the processable surface is low-heated (approximately up to 10° C., only) due to the extremely shot laser beam action time.

The invention relates to a method for finely polishing/structuring thermosensitive dielectric materials by laser radiation.

The ultraprecise technique comprises processing methods, by which bodies and surfaces with macroscopic measurements are produced with extreme precision of form and smoothness. The more precisely smoothed and formed the surfaces are, the better the optical properties they will have. However, the processing of the most various materials must be investigated because the spectrum of the optically usable wavelengths is very wide. In addition to ever-smoother more precisely formed lenses that must be produced for the visible range, optics for the infrared range as well as the UV and x-ray ranges are increasingly required. For this purpose, an increasing perfection in the art of polishing is needed, comprising a combination of conventional and completely new production methods.

In addition to the classical mechanical methods, essentially two methods are known today that use beams to polish materials.

On the one hand there is the established method with ion beams for finely polishing dielectric materials; on the other hand there is the method using CO² lasers. In addition, a method for polishing metals with YAG lasers has existed for some time.

Both laser methods utilize the short-term fusion of the surface to smooth out unevennesses, thereby achieving a polished effect. To this end, the energy density at the surface is to be selected such that no destructive removal occurs, but rather only fusion and vaporization of the microscopically small peaks. For example, the fiber ends of optical fibers are processed with CO² lasers to transmit high laser powers, such as is described in Appl. Optics, Vol. 39, No. 33, Nov. 20, 2000, 6136-6143. Complex metal forms are polished with the YAG laser (see, e.g., DGM AKTUELL 2001, 3, No. 12, “Light polishes metal” and/or DE 102 28 743 A1), for which manual labor was once largely necessary. Neither of these laser methods based on the melting method are, however, suitable for thermosensitive materials such as Zerodur in which smoothing of the surface may be accompanied only by an inconsequential increase in temperature.

Because of this, ion beams are currently used to finely polish such materials. The disadvantage is, among other things, the necessity of a vacuum apparatus, which becomes more costly as the processable components increase in size.

The object of the invention is therefore to disclose a method for fine-polishing/structuring thermosensitive dielectric materials, in particular with a low thermal expansion coefficient, by laser radiation.

This object is achieved according to the invention by a method whereby the intense ultrashort laser radiation is directed at a surface of the material being processed, and the action time of the laser radiation on the surface is adjusted to within a range between 10⁻¹³ sec and 10⁻¹¹ sec, and the energy of the laser pulses is adjusted such that it is less than the ablation threshold but sufficient to provoke a Coulomb explosion.

The method according to the invention enables material removal in the nanometer range, using ultrashort laser pulses in the picosecond and sub-picosecond range, whereby the material surface is finely polished during a pre-ablative process step (removal below the ablation threshold). As a result of the extremely short action time of the laser radiation on the surface being processed, a very small amount of heating takes place, which is only in the range of a few tens of degrees. Because of this, the method according to the invention can be referred to as a cold processing method. This method is carried out in air, i.e., no costly vacuum devices are needed, so that online control of sample removal is possible.

The solution according to the invention exploits the so-called Coulomb explosion effect (as, for example, described in Phys. Rev. B 62 (2000) 13167-13173; Phys. Rev. Letters 88, (2002) 097603; Appl. Phys. A 79 (2004) 1153-1155). In this effect, only material in the region close to the surface (0.1 to a few nm) is ejected by the action of intense ultrashort laser radiation on the surface. In the process, electrons are emitted from the surface by photoionization, and this in such numbers as a consequence of the high laser intensity that the remaining ions in the region close to the surface are subjected to such high electrostatic stress that separation of these ions occurs.

In one embodiment, adjustment of the necessary energy density is provided such that the fluence of the laser radiation on the surface being processed can be adjusted to between 70% and 95% of the threshold fluence. This may, for example, be accomplished by arranging the surface being processed in front of the focus of the laser beam.

In another embodiment, the surface being processed is scanned with the laser beam. This may be relatively simply accomplished using the known means because the method according to the invention works in air.

The invention will now be explained in greater detail with reference to an embodiment shown in the drawings, in which:

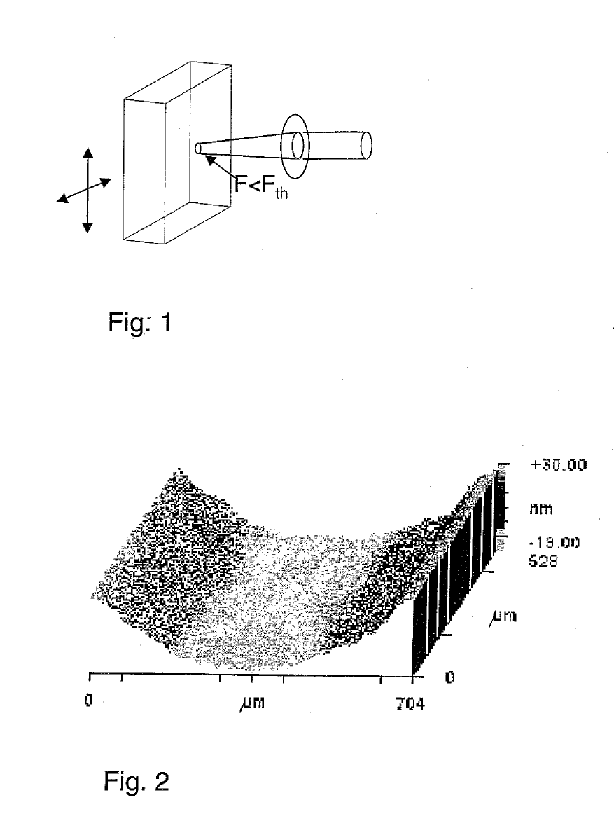

FIG. 1 is a schematic of the principle of an embodiment of the invention;

FIG. 2 shows the surface after processing with the method according to the invention.

In the embodiment, the Zerodur surface was processed using the method according to the invention. Here, the laser beam was focused in the direction of the sample with the help of a lens, such that the sample surface was located in front of the focus, as shown in FIG. 1. The position of the sample surface was selected such that fluence F was approximately 70% to 95% of the fluence threshold Fₜₕ. Positioning behind the focus is not possible because, given the high laser intensities, a plasma breakthrough occurs in the air in the region of the focus, which leads to destruction of the beam profile, and to energy loss. A rectangular aperture was further placed in the laser beam to approximately simulate a top hat profile. Although modifications occurred in the inside of the sample (imperfections), these were so deep that they had no effect on the sample surface. This top hat profile was selected because removal in a scanning method proved to be more promising in achieving less roughness than in an imaging process. In this embodiment, the sample surface is scanned strip-wise with the laser beam, and the strips are set next to each other. Because the overlap of the strips was inadequate with the initial profile (Gaussian profile) of the ultrashort pulse laser with regard to the roughness of the sample surface, this approximate top hat profile was used as well.

Such a top hat profile may, however, also be produced by a controllable diffractometric optical element (DOE), or such a DOE is used which produces a desired top hat profile directly on the surface being processed.

The laser system used was an enhanced commercial TiSa with a pulse width of 50 fs at a wavelength of 800 nm. No variation in wavelength has yet been implemented, although only the wavelength of the second harmonic (approximately 400 nm) of the output radiation would be conceivable as a potential wavelength because only with it is potentially adequate energy available.

FIG. 2 shows a wide strip which was produced at a traverse speed of 0.1 mm/sec, and which was removed below the ablation threshold with the method according to the invention. Here, the fluence F was approximately 80% of the fluence threshold, i.e., the fluence value that would be necessary for ablation of the material, and is equal to 1.6 J/cm². The sample was located 3.9 mm from the focus of a 50 mm lens. The laser energy per pulse was 0.9 mJ after the square aperture, and the pulse repetition rate of the laser was 700 Hz. This means that approximately 500 pulses strike almost the same sample site during the method according to the invention. 20 lines were placed adjacently, at a distance of Δz=70 μm from each other, respectively. The figure shows uniform, homogeneous removal; individual lines are not perceptible. Naturally, more lines can be placed adjacent to each other. The result is then removal over the entire surface of the sample. The roughness of the surface being processed with the method according to the invention was rms-roughness=1±0.15 nm.

1. Method for finely polishing/structuring thermosensitive dielectric materials with laser radiation, wherein
intense ultrashort laser radiation is directed at a surface of the material being processed, and
the action time of the laser radiation on the surface is in a range between 10⁻¹³ sec and 10⁻¹¹ sec, and the energy of the pulses is set below the ablation threshold, but is sufficient to provoke a Coulomb explosion.

2. Method according to claim 1, wherein
the fluence of the laser radiation on the surface being processed is set at between 70% and 95% of the fluence threshold.

3. Method according to claim 2, wherein
the surface being processed is arranged in front of the focus of the laser beam.

4. Method according to claim 1, wherein
the surface being processed is scanned with the laser beam.

5. Method according to claim 4, wherein
a top hat profile is set as the profile of the laser radiation directed at the surface being processed.
